(19) United States
(12) Patent Application Publication
(10) Pub. No.: US 2025/0284110 A1
(43) Pub. Date: Sep. 11, 2025

(54) COMPOSITE MONOLITHIC TELESCOPES FOR APERTURE SCALING

(71) Applicant: Lawrence Livermore National Security, LLC, Livermore, CA (US)

(72) Inventor: Frank Ravizza, Livermore, CA (US)

(21) Appl. No.: 19/067,792

(22) Filed: Feb. 28, 2025

Related U.S. Application Data
(60) Provisional application No. 63/562,085, filed on Mar. 6, 2024.

(51) Int. Cl. G02B 23/02; G02B 17/06

(52) U.S. Cl. CPC G02B 23/02; G02B 17/0636

(57) ABSTRACT

Disclosed embodiments enable scaling of monolithic optical systems (e.g., monolith telescopes) up to larger aperture sizes while reducing mass scaling. An example optical system includes a monolithic mirror assembly that integrates a primary mirror and a tertiary mirror in static alignment. The optical system further includes a secondary mirror or fold mirror displaced away from the monolithic mirror assembly and having a reflective mirror surface. The secondary mirror's reflective mirror surface is positioned to direct light received from the primary mirror onto the tertiary mirror and direct light received from the tertiary mirror onto a detector. The secondary mirror is particularly configured to maintain a low alignment sensitivity, consistent with the permanent fixed alignment associated with the monolithic mirror assembly. For example, the secondary mirror has a relatively low power curvature and a weak fourth-order shape insensitive to decentering and tip/tilt misalignments when directing light onto the spherical tertiary mirror.

### CROSS-REFERENCE TO RELATED APPLICATIONS

This patent application claims the benefit of priority of U.S. Provisional Patent Application No. 63/562,085, filed on Mar. 6, 2024, the entire contents of which are hereby incorporated by reference.

### FEDERALLY SPONSORED RESEARCH OR DEVELOPMENT

This invention was made with Government support under Contract No. DE-AC52-07NA27344 awarded by the United States Department of Energy. The Government has certain rights in the invention.

### TECHNICAL FIELD

The present disclosure relates to optical systems that can be applied, for example, as a telescope.

### BACKGROUND

Optical systems for space and airborne applications are subject to significant shock and vibration during flight and even more so during launch. Most optical systems including telescopes are very sensitive to alignment of the optical components. Even if alignment is not an issue, optical components can be damaged during launch because of the forces exerted on those components. New optical systems that robustly maintain alignment and feature higher tolerance are needed.

### SUMMARY

Embodiments of the present disclosure relate to composite monolithic telescopes, or composite configurations for monolithic telescopes that enable scaling of aperture size without exceeding mass constraints. For example, disclosed embodiments of composite monolithic telescopes can be scaled up beyond a half-meter aperture size without significant increase in system mass. According to one aspect of the present disclosure, an optical system comprises a monolithic mirror assembly that integrates a primary mirror and a tertiary mirror in static alignment. The optical system further comprises a secondary mirror or fold mirror that is displaced away from the monolithic mirror assembly and has a reflective mirror surface. The secondary (or fold) mirror's reflective mirror surface is positioned to direct light received from the primary mirror onto the tertiary mirror and direct light received from the tertiary mirror onto a detector integrated within the monolithic mirror assembly.

The disclosed embodiments address technical challenges related to applied optical systems, such as optical systems for space and airborne applications. First, the disclosed embodiments include a monolithic component that statically or fixedly aligns the primary and tertiary mirrors, thereby providing alignment tolerance for the system and reducing the need for mechanical alignment structures. Further, the disclosed embodiments reduce the size scaling challenges associated with monolithic telescope systems, where the mass thereof scales with optical aperture size cubed. Instead, the composite monolithic telescopes have reduced mass due in part to the integration of a secondary mirror or fold mirror displaced away from the monolithic mirror assembly. The secondary or fold mirror is particularly configured to maintain a low alignment sensitivity, consistent with the low alignment sensitivity associated with the monolithic mirror assembly. For example, the secondary mirror has a relatively low power curvature and a weak fourth order shape that provides insensitivity to decentering and tip/tilt misalignments when directing light onto a spherical tertiary mirror within the monolithic mirror assembly.

### BRIEF DESCRIPTION OF THE DRAWINGS

FIG. 1A depicts an example of a Cassegrain telescope made using monolithic optical technology.

FIG. 1B depicts process improvements associated with monolithic optical systems according to embodiments of the disclosed technology.

FIGS. 2A and 2B depict a size scaling of monolithic optical systems according to embodiments of the disclosed technology.

FIGS. 3A-3C depict examples of a scaled composite monolithic optical system for aperture scaling, according to embodiments of the disclosed technology.

FIG. 4 depicts a coupling structure for a secondary mirror or fold mirror component of a scaled composite monolithic optical system, according to embodiments of the disclosed technology.

FIG. 5 shows a table with example values for alignment characteristics of an example scaled composite monolithic optical system, according to embodiments of the disclosed technology, and other optical systems.

FIGS. 6A-6C show example values for optical properties used in an example scaled composite monolithic optical system, according to embodiments of the disclosed technology.

FIGS. 7A-7B show example values for physical properties used in an example scaled composite monolithic optical system, according to embodiments of the disclosed technology.

FIG. 8 shows an example method for manufacturing a scaled composite monolithic optical system, according to embodiments of the disclosed technology.

### DETAILED DESCRIPTION

Disclosed embodiments include methods, devices, and systems related to a composite monolithic optical system. Monolithic telescopes are cheap, intrinsically robust, and provide high performance. Substantial cost is expended to ensure optical system alignment and to perform frequent testing (and re-testing) of high sensitivity optical elements throughout assembly, integration, and test of the optical system. Solid monoliths have proven that they can eliminate these risks and costs due to their inherently insensitive construction using environmentally robust materials and manufacturing approaches. But due to mass scaling with aperture cubed, solid monoliths mass becomes excessive beyond certain aperture sizes. For example, beyond a half-meter aperture, a solid monolith's mass can approach 1000 kilograms. The disclosed embodiments enable design and construction of solid monolithic telescopes at larger scales, such as meter-class (aperture size of at least one meter) and beyond.

The disclosed embodiments use a folded Gregorian-like optical design approach that allows all high-sensitivity optical components to be integrated into a single monolithic structure, thus permanently aligning these optical components as in solid monolith systems. Meter-scale and beyond can be achieved at least in-part through the use of a quasi-flat secondary mirror or a flat “fold mirror,” which is insensitive to translation. Finally, in some embodiments, field correcting optical lenses and a light sensitive focal plane array detector are integrated into the monolithic structure to complete the final telescope assembly. Accordingly, in some embodiments, a scaled (e.g., meter-class) composite monolithic optical system is a complete electro-optical system with only three low-sensitivity degrees of freedom, namely, the secondary mirror or fold mirror. This is the same number of degrees of freedom as solid monoliths (the focal plane array tip/tilt/focus). Use of a folded Gregorian-like design allows for relatively long focal lengths for the primary and tertiary mirror elements to further reduce alignment sensitivity. In some examples, the secondary mirror or fold mirror according to the disclosed embodiments tolerates as much as 100 micrometers of displacement without significantly affecting optical performance.

The remaining two degrees of freedom likewise are relatively insensitive at one milliradian. A scaled composite monolithic system can function as a simple prime focus system or can incorporate an optical relay to support multiple sensors on its optical bench integrated onto the monolithic structure. In some embodiments, the secondary mirror or fold mirror is supported and coupled to the monolithic mirror assembly that includes the primary and tertiary mirrors via a strut structure, an optical tube assembly, and/or a mirror mount. The strut structure or optical tube can provide alignment of the fold mirror along with all other optical components in the system.

Accordingly, the disclosed embodiments can substantially relax the requirements posed upon conventional precision optomechanical structures. Here, composite optics may refer to the use of more than one type of material to construct a monolith optical system. In some embodiments, glass, carbon fiber composites, metals, as well as other materials may be combined. Optics figuring and finishing of the primary and tertiary mirrors as an integrated monolithic optic may be done via optical polishing and metrology techniques. For example, high-quality optical surfaces, such as fused silica glass, may be utilized. Selected surfaces are easily polishable but also easily coated and have small coefficients of thermal expansion that are most favorable for optical mirror substrates. Glass materials may also be selected to allow operation at short wavelengths, from the visible spectrum down into the ultraviolet spectrums. Other materials may include moldable fused silica glass, and/or other materials which can be formed by a mandrel, as well as carbon composite materials appropriate for structural support components (e.g., the strut or tube assembly for the secondary/fold mirror). Furthermore, a composite monolithic optical system also integrates an optical bench formed within the primary-tertiary mirror structure and incorporates a mounting interface between the telescope and bus.

The disclosed approaches incorporate all critical elements into one monolithic structure to ensure the entire optical system is thermally and acoustic/vibrationally robust to the operational space environment, ensuring permanent alignment of key optical prescription parameters.

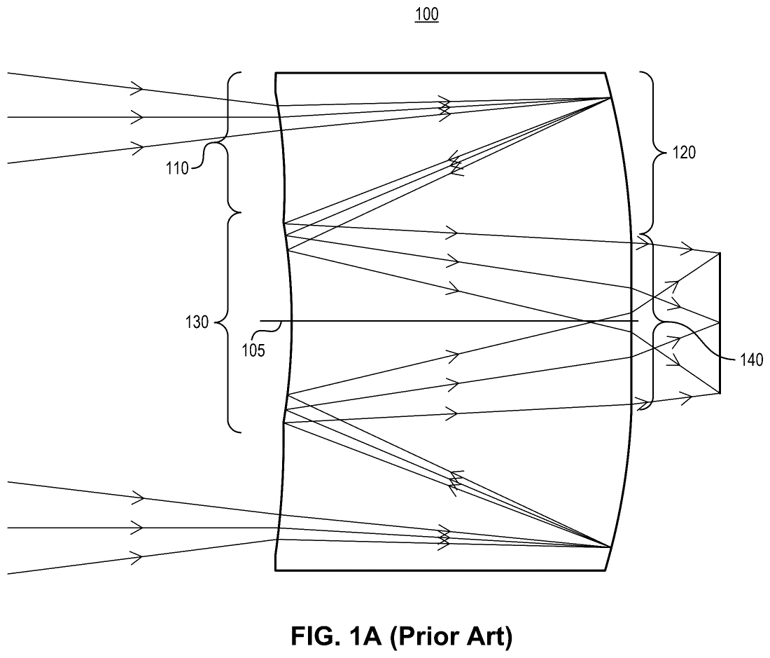

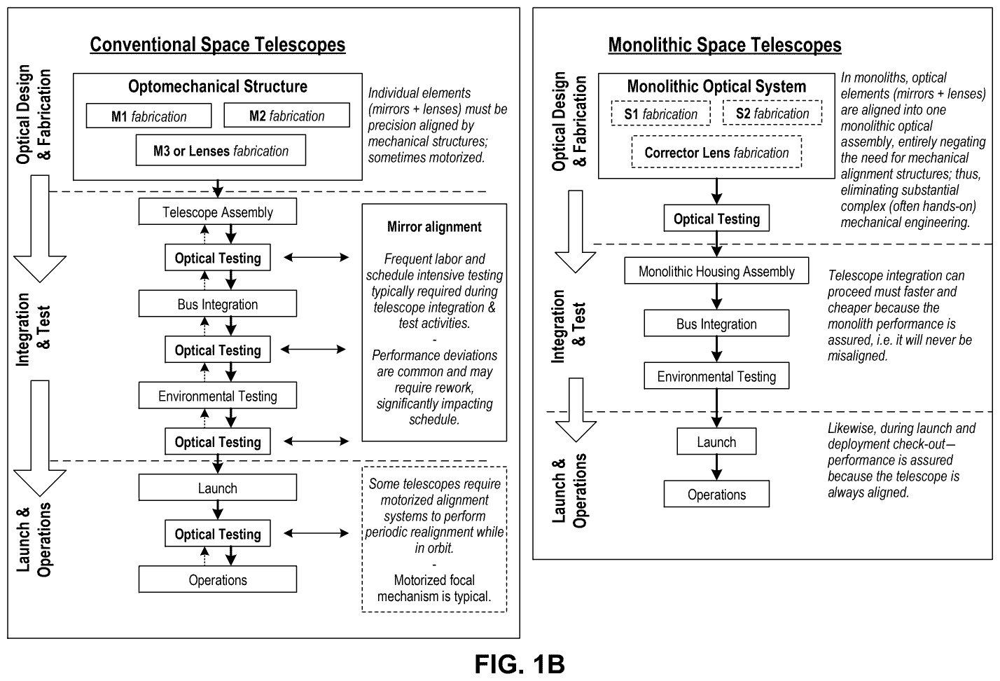

FIG. 1A depicts an example of a solid monolithic telescope including aspheric first and second refractive surfaces and mirrors made using monolithic optical technology. FIG. 1 shows a cross-sectional view of a telescope 100. The telescope 100 may be a Cassegrain-type or Cassegrain-like optical system. Telescope 100 is circularly symmetric about axis 105 and includes a first refractive surface 110, first reflective surface 120, a second reflective surface 130, and second refractive surface 140. The first refractive surface 110, first reflective surface 120, second reflective surface 130, and second refractive surface 140 may each be produced according to a different prescription. Each prescription can be described by a different mathematical polynomial that specifies the shape of the corresponding surface.

Examples of solid monolithic telescopes are disclosed in U.S. patent application Ser. No. 17/654,775 titled “WIDEFIELD CATADIOPTRIC MONOLITHIC TELESCOPES” filed on Mar. 14, 2022, and U.S. patent application Ser. No. 18/506,920 titled “MONOLITHIC SPACE TELESCOPES AND MOUNTING SYSTEM” filed on Nov. 10, 2023. The contents of each of the aforementioned applications are incorporated herein by reference in their entireties.

FIG. 1B depicts process improvements associated with monolithic optical systems according to embodiments of the disclosed technology. Conventional space telescopes include individual elements (e.g., mirrors, lenses) that must be precision aligned by mechanical structures and that are sometimes motorized, leading to technical challenges and costs with the optical design and fabrication of such conventional (or non-monolithic) telescopes. Furthermore, with integration & test, frequent labor and intensive testing is typically required, and rework is frequently required for performance deviations. For instance, the James Webb Space Telescope is an extreme example of High Complexity, High Risk convention (non-monolithic) space telescope.

On the other hand, monolithic telescopes or optical systems have optical elements (e.g., mirrors, lenses) that are aligned into one monolithic optical assembly, thus negating or minimizing the need for mechanical alignment structures and eliminating/reducing substantially complex mechanical challenges and costs, at least with respect to optical design and fabrication. Because misalignment in a monolith is minimized, integration and test proceeds much faster and cheaper. Monolithic systems thus address various challenges associated with conventional (non-monolithic) systems, as monolithic systems reduce size, weight, and power (SWaP) and can be delivered on a shorter schedule at lower cost by eliminating high-precision mechanical structures and by eliminating risk, testing, and rework.

Table 1 below also describes the benefits associated with monolithic optical systems. Generally, monolithic systems offer greater robustness and reliability with the goal of reducing cost of proliferated constellations.

TABLE 1

| | Example Monolithic Telescopes | | Non-Monolithic Cassegrain Systems | |
|---|---|---|---|---|
| Launch | Any orientation | | Typically orientation dependent | |
| Orientation | | | | |
| Launch | >14.1 | g-rms | Typically designed for specific | |
| Acceleration | | | launch vehicle | |
| Bus Options | Flexible (can be off-the-shelf | | Typically designed for specific bus | |
| | payloads) | | | |
| Mirror Alignment | Not required (re-testing also not | | Mirror alignment typically required | |
| | needed) | | | |
| Optical | 0.9 degree FOV, f/8, ø60 mm | | Equivalent performance very difficult | |
| Specifications | diameter image circle | | & costly | |
| Optical | Diffraction Limited | | Active alignment required at | |
| Performance | | | equivalent performance and SWaP | |
| Optical Spec. | Highly flexible and readily done | | Extensive redesign NRE & analysis | |
| Flexibility | w/o mechanical redesign | | required | |
| Thermal | Inherently insensitive & | | Extensive system thermal optical | |
| Performance | passively controlled. Slowly | | performance (STOP) analysis and/or | |
| | varying defocus converges to | | active controls required | |
| | quasi-static in steady state sun | | | |
| | orientations (e.g., SSO). | | | |
| Payload Mass | ~70 | kg | <30 | kg |
| Telescope Volume | ~80 | L | >200 | L |

As illustrated in FIG. 1A, the first refractive surface 110, the first reflective surface 120, the second reflective surface 130, and the second refractive surface 140 form a complete optical system integrated into a solid body, for example, composed of fused silica glass. Because of the solid body integration, the optical system's mass is proportional to an aperture diameter cubed. For example, the mass of telescope 100 may be proportional to 500 [kg/m³]*D³, with D representing an aperture diameter embodied by the outer diameter of the first refractive surface 110. Accordingly, in some examples, a solid monolithic telescope may be limited to aperture sizes of 50 centimeters, where aperture sizes therebeyond exceed mass and weight requirements in certain applications.

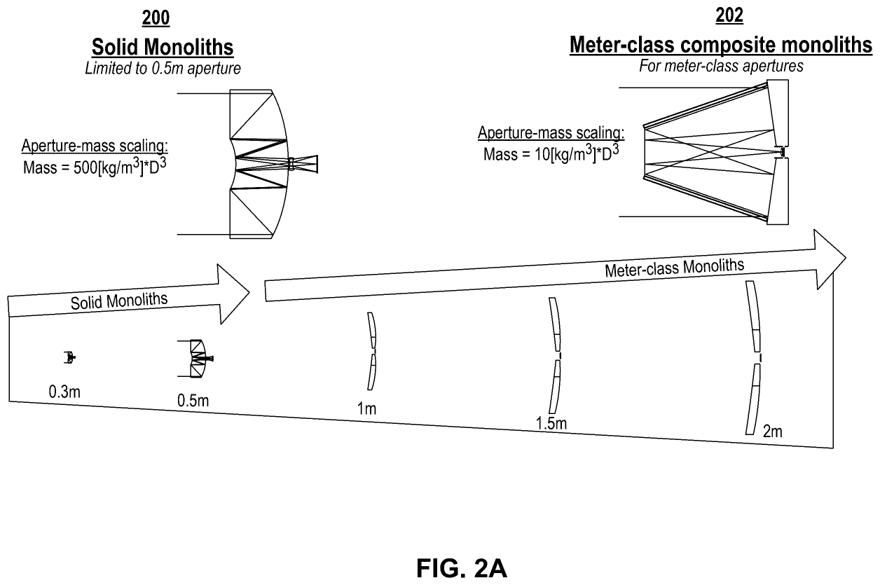

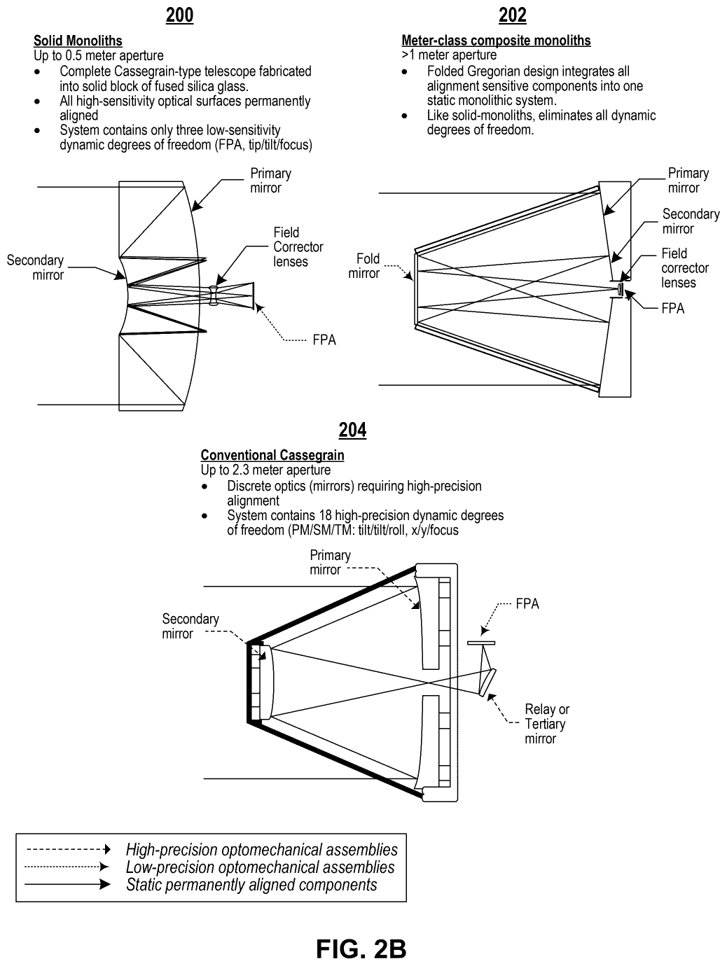

FIGS. 2A and 2B compare the solid monolithic optical systems with the scaled composite monolithic optical systems disclosed herein. As shown in FIGS. 2A and 2B, size scaling of a solid monolithic optical system 200 may be limited to a certain range or class of aperture sizes based on its mass scaling. For example, in space telescope applications in which mass is constrained for space launch, a solid monolithic optical system 200 is limited to a half-meter aperture size. FIGS. 2A-2B depict a scaled composite monolithic optical system 202. The scaled composite monolithic optical system 202 can be applied for a larger range or class of aperture sizes, such as a meter-class for space telescope applications. The scaled composite monolithic optical system 202 has a mass scaling less than that of the solid monolithic optical system 200.

In particular, the scaled composite monolithic optical system 202 can be scaled to larger aperture classes based on its folded Gregorian-like or Gregorian-type design that integrates all alignment sensitive components into one static monolithic structure or assembly. The folded Gregorian design is distinct from the Cassegrain design in the solid monolithic optical system 200. FIG. 2B also compares the scaled composite monolithic optical system 202 with a conventional Cassegrain system 204. Being a non-monolithic system, the conventional Cassegrain system 204 requires high-precision optomechanical assemblies for active alignment of a primary mirror, a secondary mirror, and a relay or tertiary mirror. Accordingly, the conventional Cassegrain system 204 is susceptible to the alignment challenges presented in some optical system applications. In comparison, the scaled composite monolithic optical system 202 includes a low-precision optomechanical assembly for the fold mirror, and the remaining optical elements are permanently and statically aligned.

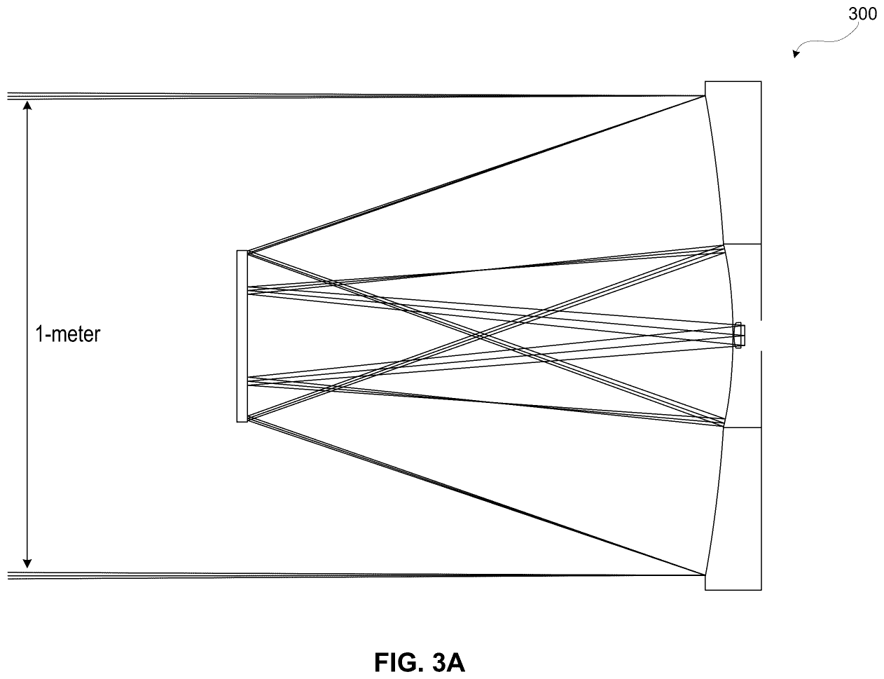

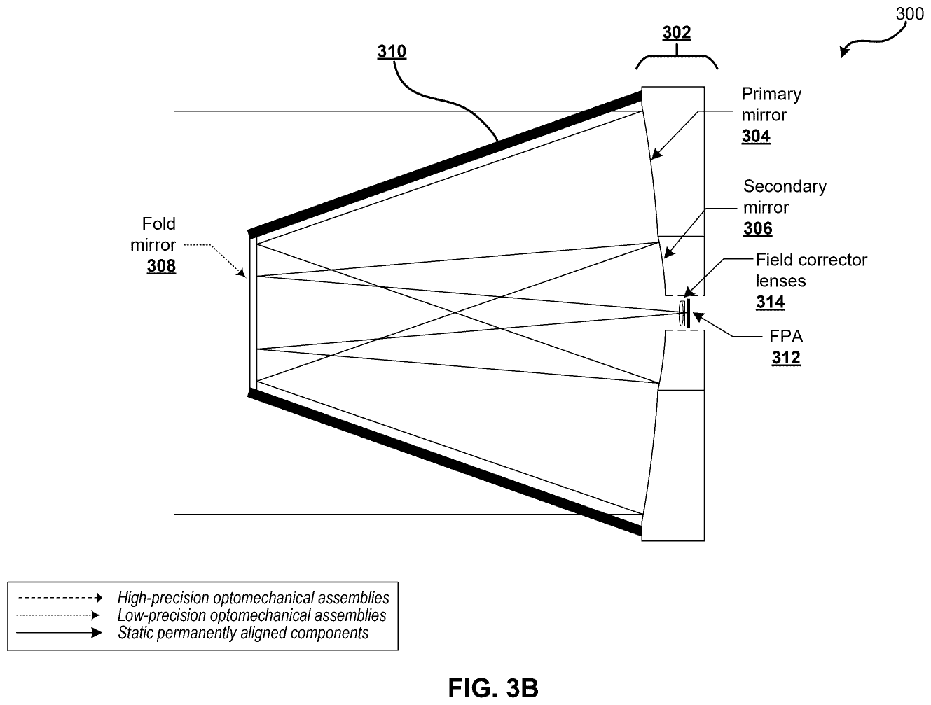

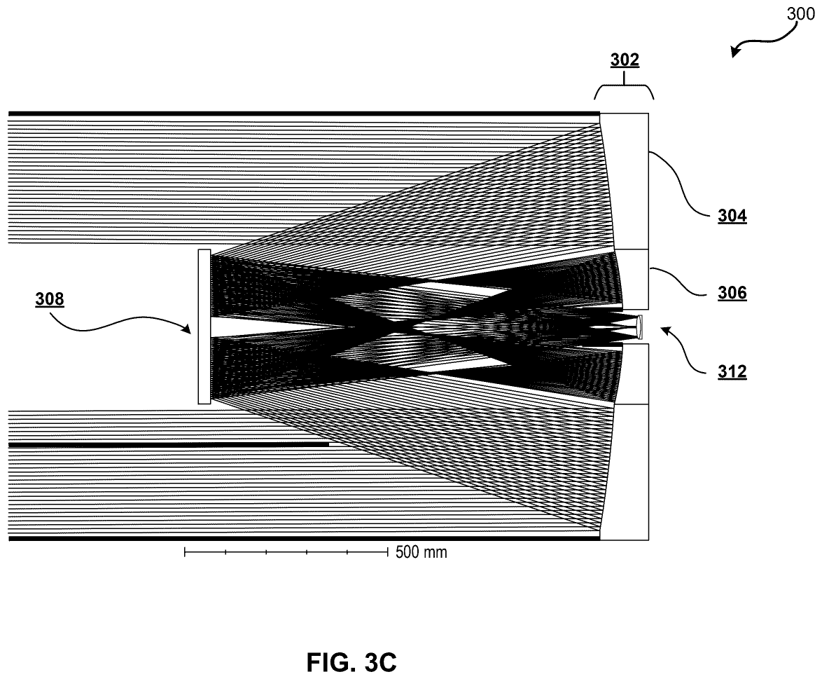

FIGS. 3A-3C depict examples of a composite monolithic optical system for aperture scaling. As illustrated, a composite monolithic telescope 300 having an aperture size of one meter. The composite monolithic telescope 300 includes a monolithic mirror assembly 302, which integrates a primary mirror 304 and a tertiary mirror 306 in permanent static alignment. The primary mirror 304 and the tertiary mirror 306 are defined respectively by reflective surfaces on the monolithic substrate. In some embodiments, the primary mirror 304 is aspherical and the tertiary mirror 306 is spherical. In some embodiments, the primary mirror 304 is defined by a hyperbolic shape.

The composite monolithic telescope 300 further comprises a secondary/fold mirror 308. By integrating the secondary/fold mirror 308, the desired local lengths for some optical system applications that are larger than the composite monolithic telescope 300 can be achieved. With respect to an overall lightpath, the secondary/fold mirror 308 is between the primary mirror 304 and the tertiary mirror 306. The primary mirror 304 receives input light (of the scaled aperture size, for example, of one meter), and the primary mirror 304 reflects the input light onto the secondary/fold mirror 308. The secondary/fold mirror 308 then reflects the light received from the primary mirror 304 onto the tertiary mirror 306. The tertiary mirror 306 reflects the light received from the secondary/fold mirror 308 back onto the fold mirror 308, and the secondary/fold mirror 308 reflects the light received from the tertiary mirror 308 onto a detector 312, such as a camera or a focal plane array (FPA) detector. In some embodiments, the light reflected by the secondary/fold mirror 308 onto the detector 312 passes through one or more lenses or mirror elements providing field correction. These lenses or mirror elements for field correction may be spherical. Similar to a Gregorian telescope design, the light comes into focus along the lightpath prior to reaching the tertiary mirror 306.

As shown, the secondary/fold mirror 308 is displaced or positioned away from the monolithic mirror assembly 302, and the secondary/fold mirror 308 is secured or coupled with the monolithic mirror assembly 302 via a coupling structure 310 (e.g., one or more struts, an optical tube assembly). The secondary/fold mirror 308 may be coupled to a low-precision optomechanical assembly that allows three dynamic degrees of freedom for the fold mirror 308. Despite having some degrees of freedom, the secondary/fold mirror 308 has low sensitivity to misalignment (e.g., measured by center thickness (CT) over tilt). In particular, the secondary/fold mirror 308 provides low sensitivity or insensitivity to decentering and tip/tilt misalignment based on being quasi-flat, or defined by a low power curvature and a weak fourth-order shape (or a shape defined by a fourth-order polynomial). In some embodiments, the secondary/fold mirror 308 is flat. For example, the secondary/fold mirror 308 is a Schmidt plate. In some examples, the fold mirror 308 provides a decentering tolerance of ±50 μm, a tip/tilt tolerance of ±0.5 mrads, and a Z tolerance of 50 μm (with a focus mechanism).

The detector 312 that receives light from the secondary/fold mirror 308 is integrated within the monolithic mirror assembly 302 and is accordingly permanently and statically aligned with the primary mirror 304 and the tertiary mirror 306. In some embodiments, the monolithic mirror assembly 302 further comprises field corrector lenses 314 with the detector 312. The field corrector lenses 314 may be defined by a spherical shape and can be interchanged depending on spectral band. Due to integration with the monolithic mirror assembly 302, the field corrector lenses 314 are permanently and statically aligned with the primary mirror 304, the tertiary mirror 306, and the detector 312. In some embodiments, the monolithic mirror assembly 302 further comprises other optical elements such as optical filters, heat filters or shields, and/or the like.

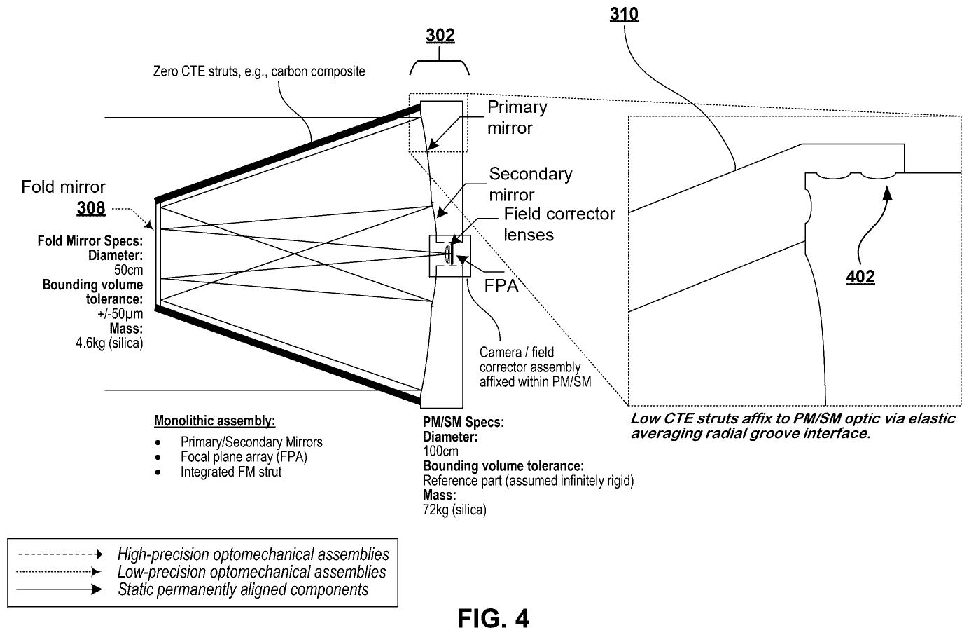

FIG. 4 depicts a coupling structure for the secondary/fold mirror component of a composite monolithic telescope. As illustrated, a coupling structure 310 couples the secondary/fold mirror 308 with the monolithic mirror assembly 302. For example, the coupling structure 310 comprises one or more struts that span between the secondary/fold mirror 308 and the monolithic mirror assembly 302. As another example, the coupling structure 310 is integrated as part of an optical tube assembly within which the monolithic mirror assembly 302 and the secondary/fold mirror 308 is secured. In some embodiments, the coupling structure 310 comprises a mounting interface 402 via which the coupling structure 310 is attached with the monolithic mirror assembly 302. In some embodiments, the mounting interface 402 comprises one or more pairs of ridges and grooves; for example, the coupling structure 310 may include a ridge surface that interfaces with a groove surface on the monolithic mirror assembly 302. A ridge-groove pair of the mounting interface 402 may be rectangular, triangular, sinusoidal, and/or the like in shape. In some embodiments, the mounting interface 402 comprises an elastomeric material between corresponding ridge and groove surfaces to reduce stress/pressure and to dampen vibrations. In some embodiments, the coupling structure 310 further comprises a mounting interface for attaching to the secondary/fold mirror 308 (or a low-precision optomechanical assembly to which the secondary/fold mirror 308 is coupled).

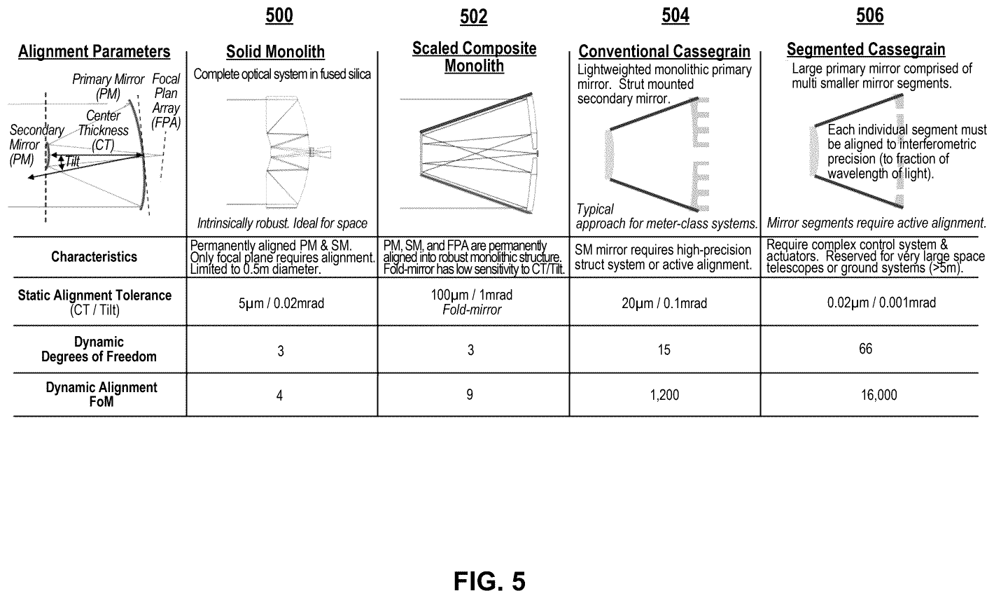

FIG. 5 shows a table with example values for alignment characteristics of a solid monolithic optical system 500, a scaled composite monolithic optical system 502, a conventional or non-monolithic Cassegrain optical system 504, and a segmented non-monolithic Cassegrain optical system 506. The values shown are for example values presented for illustration purposes. Other example systems incorporating the disclosed subject matter will have different values dependent on the design goals and optimization performed. As indicated in FIG. 5, the monolithic systems may have three dynamic degrees of freedom, which is significantly less than that of the non-monolithic Cassegrain systems. As also indicated in FIG. 5, the scaled composite monolithic optical system 502 exhibits a high static alignment tolerance compared to the other optical systems. In some embodiments, the high static alignment tolerance is enabled at least in part by monolithic alignment of the primary and tertiary mirrors, the secondary/fold mirror being an aspheric quasi-flat reflective surface, and the tertiary mirror being defined by a spherical shape.

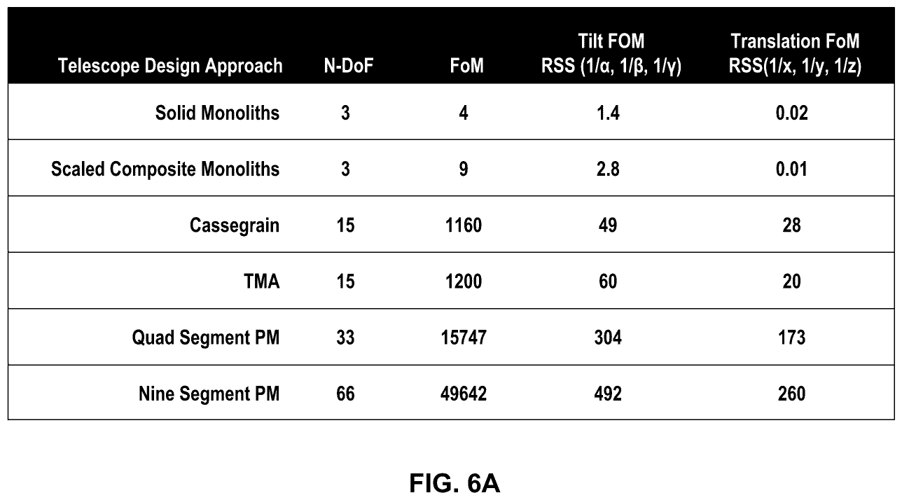

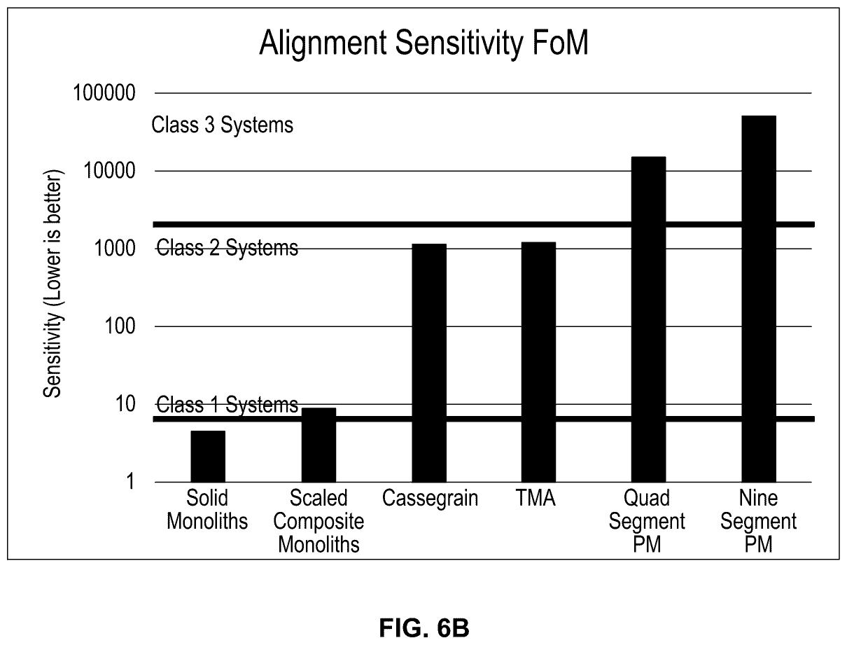

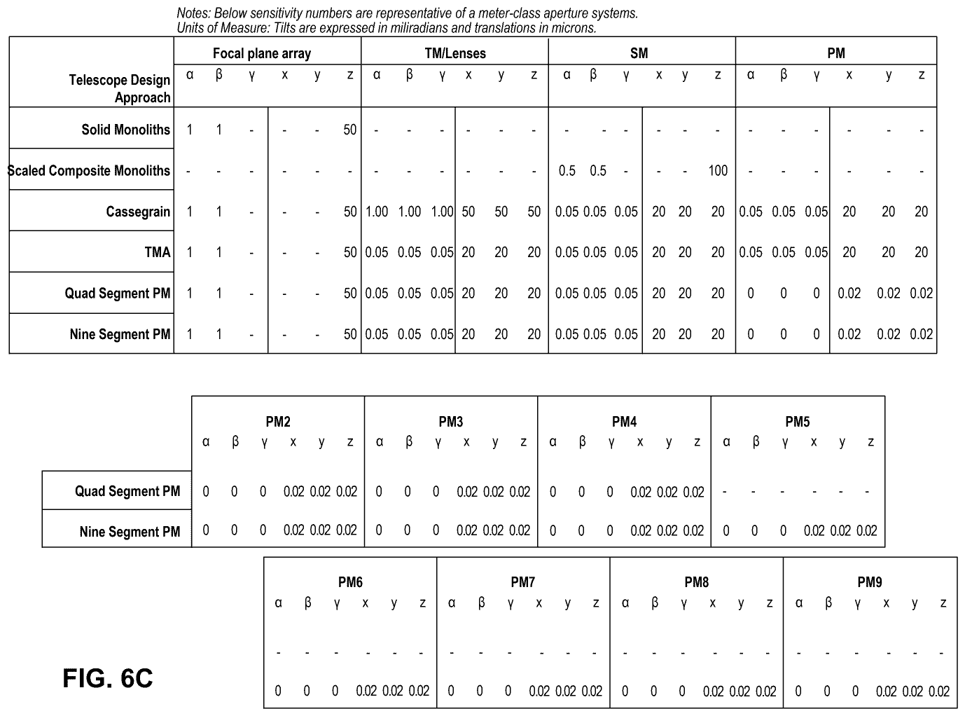

FIGS. 6A-6C show example values for optical properties used in an example composite monolithic optical system, according to embodiments of the disclosed technology. The values shown are for example values presented for illustration purposes. Other example systems incorporating the disclosed subject matter will have different values dependent on the design goals and optimization performed. Again, these example values demonstrate the retention of the relatively low dynamic degrees of freedom associated with solid monoliths with the scaled composite monolithic optical system, as well as the low alignment sensitivity exhibited by solid monoliths and scaled composite monolithic optical systems.

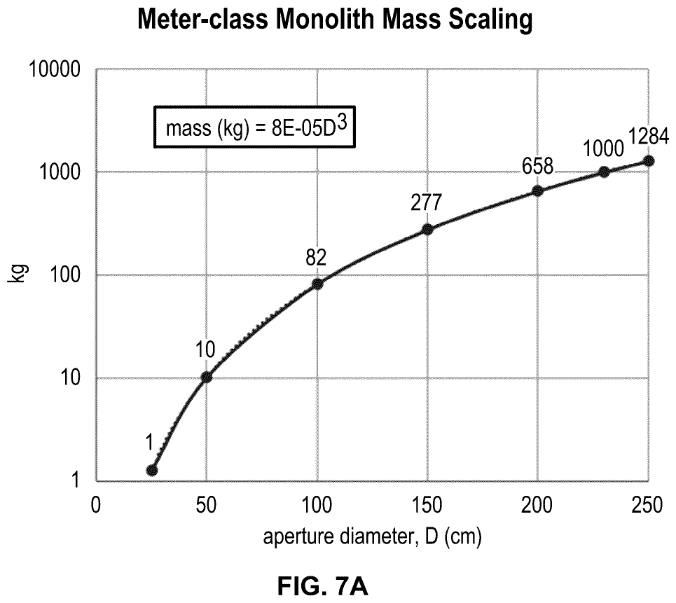

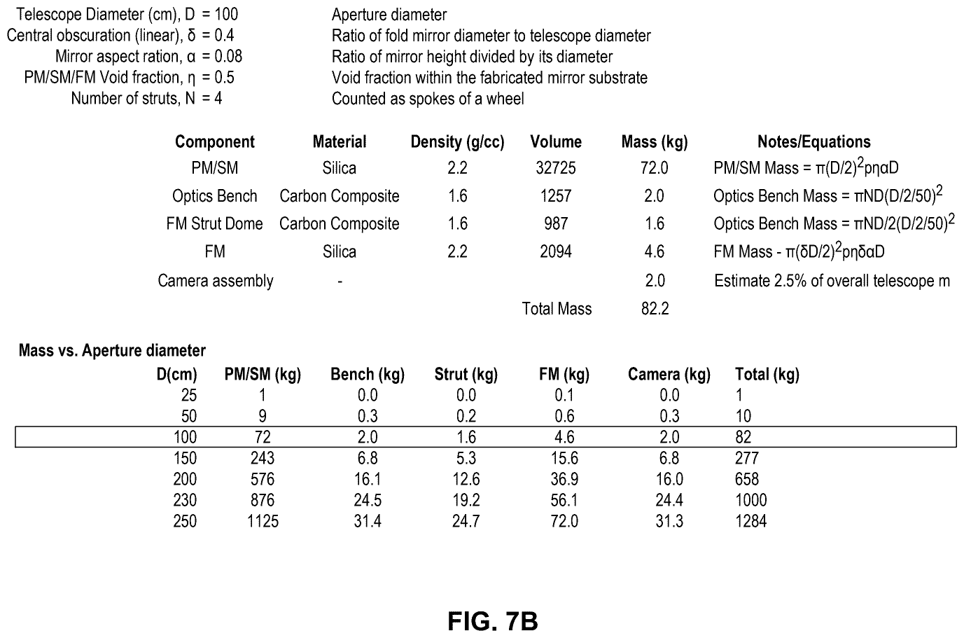

FIGS. 7A-7B show example values for scaled physical properties used in an example composite monolithic optical system, according to embodiments of the disclosed technology. The values shown are for example values presented for illustration purposes. Other example systems incorporating the disclosed subject matter will have different values dependent on the design goals and optimization performed. The illustrative example values demonstrate the mass scaling with respect to aperture size for the scaled composite monolithic optical system. In contrast to an example solid monolith which reaches 1000 kg at an aperture size of one meter, an example scaled composite monolithic optical system can scale up to an aperture size of around 2.3 meters before reaching 1000 kg. Further, the mass of an example scaled composite monolithic optical system at an aperture size of one meter is 82 kg, which is significantly less than that of a solid monolith at the same aperture size. Thus, examples of scaled composite monolithic optical system provide mass efficiency that allows use thereof in mass-constrained applications, such as space telescope applications.

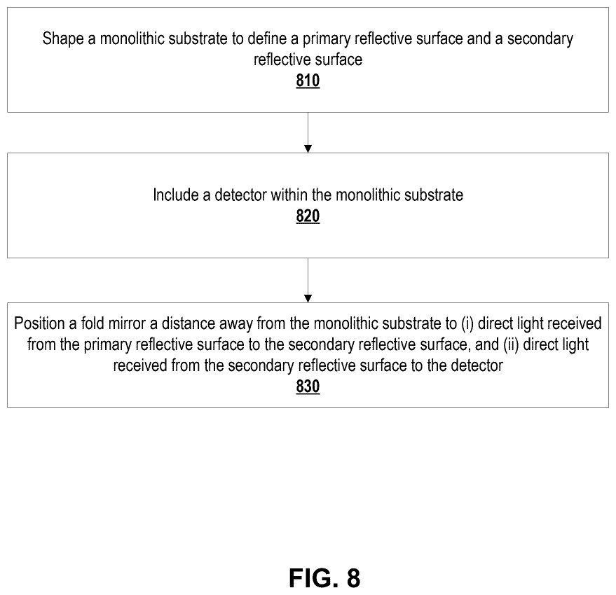

FIG. 8 shows an example method for manufacturing a scaled composite monolithic optical system, according to embodiments of the disclosed technology. At 810, the method includes shaping a monolithic substrate to define a primary reflective surface and a tertiary reflective surface. The primary reflective surface embodies a primary mirror of the optical system, and the tertiary reflective surface embodies a tertiary mirror of the optical system. In some embodiments, the primary reflective surface and the tertiary reflective surface are shaped in a single block of substrate (e.g., a block of silica glass). In some embodiments, the primary reflective surface and the tertiary reflective surface are respectively shaped in separate blocks of substrate that are fused together to form the monolithic substrate. In some embodiments, the primary reflective surface is aspheric and hyperbolic in shape. In some embodiments, the tertiary reflective surface is spherical in shape. By defining the primary reflective surface and the tertiary reflective surface on the monolithic substrate, the primary reflective surface and the tertiary reflective surface are fixed in a permanent alignment. In some embodiments, the method further includes applying reflective coating to the monolithic substrate to produce the primary reflective surface and the tertiary reflective surface. In some embodiments, an aperture size of the optical system that is based on an outer diameter of the primary reflective surface is at least one meter.

At 820, the method comprises including a detector within the monolithic substrate. In some embodiments, the detector is a camera, a focal plane array, and/or the like. In some embodiments, the detector is included along a center axis through the monolithic substrate; for example, the detector is located at a center of an area spanned by the tertiary reflective surface. In some embodiments, the detector included within the monolithic substrate is an assembly that further comprises field corrector lenses, optical filters, heat filters, and/or the like. In some embodiments, the detector includes field corrector lenses defined by a spherical shape.

At 830, the method includes positioning a secondary/fold mirror at a distance away from the monolithic substrate. The secondary/fold mirror may be positioned away from the monolithic substrate via a strut structure that is coupled to the monolithic substrate. The secondary/fold mirror includes a reflective surface, and the secondary/fold mirror is positioned so that its reflective surface directs light received from the primary reflective surface onto the tertiary reflective surface and also directs light received from the tertiary reflective surface onto the detector. In some embodiments, the secondary/fold mirror is defined by a fourth-order shape; for example, the secondary/fold mirror is a Schmidt plate. In some embodiments, the secondary/fold mirror has a relatively weak curvature and is quasi-flat in order to provide insensitivity to decentering or misalignments when directing light onto the tertiary reflective surface and onto the detector. In other embodiments, the secondary/fold mirror may be flat. In some embodiments, the secondary/fold mirror is configured to focus light that it receives from the primary reflective surface before it directs the light onto the tertiary reflective surface; for example, the optical system is a Gregorian-type or Gregorian-like design where light is focused prior to reaching the tertiary mirror.

Some example technical solutions implemented by example embodiments are listed below.

1. An optical system, comprising:
a monolithic mirror assembly that integrates a primary mirror and a tertiary mirror in static alignment; and
a secondary mirror displaced away from the monolithic mirror assembly and having a reflective mirror surface positioned to (i) direct light received from the primary mirror onto the tertiary mirror, and (ii) direct light received from the tertiary mirror onto a detector through one or more lenses or mirror elements providing field correction.

2. The optical system of solution 1, wherein the reflective mirror surface of the secondary mirror is an aspheric surface.

3. The optical system of any one of solutions 1-2, wherein the reflective mirror surface of the secondary mirror is characterized by a fourth-order polynomial that limits spherical and off-axes aberrations in the light directed onto the detector.

4. The optical system of any one of solutions 1-3, wherein the secondary mirror is displaced away from the monolithic mirror assembly via one or more struts or an optical tube assembly that is coupled to the monolithic mirror assembly.

5. The optical system of solution 4, wherein the one or more struts are coupled to the monolithic mirror assembly via a groove interface that comprises a ridged or grooved surface on the one or more struts that corresponds to a grooved or ridged surface on the monolithic mirror assembly.

6. The optical system of any one of solutions 1-5, wherein the secondary mirror is coupled to a mechanical assembly allowing tilting of the secondary mirror relative to the monolithic mirror assembly.

7. The optical system of any one of solutions 1-6, wherein the monolithic mirror assembly comprises the detector and integrates the detector in static alignment with the primary mirror and the tertiary mirror.

8. The optical system of any one of solutions 1-7, wherein the tertiary mirror is defined by a spherical reflective surface that receives the light directed by the secondary mirror.

9. The optical system of any one of solutions 1-8, wherein the primary mirror is defined by a hyperbolic reflective surface.

10. The optical system of any one of solutions 1-9, wherein the monolithic mirror assembly is a fused silica glass substrate that comprises an aspheric reflective surface defining the primary mirror and a spherical reflective surface defining the tertiary mirror.

11. The optical system of any one of solutions 1-10, wherein an aperture size associated with the optical system is greater than 50 centimeters.

12. An optical system comprising:
a first aspheric reflective surface for receiving input light;
a second aspheric reflective surface; and
a third spherical reflective surface,
   wherein the second aspheric reflective surface is positioned to (i) direct light received from the first aspheric reflective surface onto the third spherical reflective surface, and (ii) direct light received from the third spherical reflective surface onto a detector,
   wherein the first aspheric reflective surface and the third spherical reflective surface are arranged in a monolithic substrate in fixed alignment with respect to each other, and
   wherein the second aspheric reflective surface is displaced at a distance away from the monolithic substrate and has a variable alignment with the first aspheric reflective surface and the third spherical reflective surface of the monolithic substrate.

13. The optical system of solution 12, wherein the second aspheric reflective surface is a Schmidt plate configured to limit spherical and off-axes aberrations in the light directed onto the detector.

14. The optical system of any one of solutions 12-13, wherein the second aspheric reflective surface is defined by a fourth-order polynomial.

15. The optical system of any one of solutions 12-14, further comprising one or more struts or an optical tube assembly that positions the second aspheric reflective surface at the distance away from the monolithic substrate.

16. The optical system of any one of solutions 12-15, wherein an aperture size of the optical system that corresponds to an outer diameter of the first aspheric reflective surface is greater than fifty centimeters.

17. The optical system of any one of solutions 12-16, wherein the detector is located within the monolithic substrate in fixed alignment with the first aspheric reflective surface and the third spherical reflective surface.

18. A method of manufacturing an optical system, the method comprising positioning a secondary mirror at a distance away from a monolithic substrate that fixes a primary mirror and a tertiary mirror in alignment, the secondary mirror positioned to direct light received from the primary mirror onto the tertiary mirror.

19. The method of solution 18, further comprising:
attaching a first end of a strut to the monolithic substrate, wherein the secondary mirror is positioned at an opposite end of the strut at the distance away from the monolithic substrate.

20 The method of solution 19, wherein the first end of the strut comprises a ridged or grooved surface that corresponds to a grooved or ridged surface on the monolithic substrate.

21. The method of any one of solutions 18-20, wherein the secondary mirror is a Schmidt plate.

22. The method of any one of solutions 18-21, wherein an aperture size associated with the optical system and defined by an outer diameter of the primary mirror of the monolithic substrate is greater than fifty centimeters.

23. A monolithic telescope comprising a secondary fold mirror displaced away from a statically-aligned assembly comprising a primary mirror and a tertiary mirror.

Although a few variations have been described in detail above, other modifications or additions are possible. In particular, further features and/or variations may be provided in addition to those set forth herein. Moreover, the example embodiments described above may be directed to various combinations and sub-combinations of the disclosed features and/or combinations and sub-combinations of several further features disclosed above. In addition, the logic flow depicted in the accompanying figures and/or described herein does not require the particular order shown, or sequential order, to achieve desirable results. Other embodiments may be within the scope of the following claim examples.

Only a few implementations and examples are described and other implementations, enhancements and variations can be made based on what is described and illustrated in this patent document. Moreover, the separation of various system components in the embodiments described in this patent document should not be understood as requiring such separation in all embodiments.

1. An optical system, comprising:
a monolithic mirror assembly that integrates a primary mirror and a tertiary mirror in static alignment; and
a secondary mirror displaced away from the monolithic mirror assembly and having a reflective mirror surface positioned to (i) direct light received from the primary mirror onto the tertiary mirror, and (ii) direct light received from the tertiary mirror onto a detector through one or more lenses or mirror elements providing field correction.

2. The optical system of claim 1, wherein the reflective mirror surface of the secondary mirror is an aspheric surface.

3. The optical system of claim 1, wherein the reflective mirror surface of the secondary mirror is characterized by a fourth-order polynomial that limits spherical and off-axes aberrations in the light directed onto the detector.

4. The optical system of claim 1, wherein the secondary mirror is displaced away from the monolithic mirror assembly via one or more struts or an optical tube assembly that is coupled to the monolithic mirror assembly.

5. The optical system of claim 4, wherein the one or more struts are coupled to the monolithic mirror assembly via a groove interface that comprises a ridged or grooved surface on the one or more struts that corresponds to a grooved or ridged surface on the monolithic mirror assembly.

6. The optical system of claim 1, wherein the secondary mirror is coupled to a mechanical assembly allowing tilting of the secondary mirror relative to the monolithic mirror assembly.

7. The optical system of claim 1, wherein the monolithic mirror assembly comprises the detector and integrates the detector in static alignment with the primary mirror and the tertiary mirror.

8. The optical system of claim 1, wherein the tertiary mirror is defined by a spherical reflective surface that receives the light directed by the secondary mirror.

9. The optical system of claim 1, wherein the primary mirror is defined by a hyperbolic reflective surface.

10. The optical system of claim 1, wherein the monolithic mirror assembly is a fused silica glass substrate that comprises an aspheric reflective surface defining the primary mirror and a spherical reflective surface defining the tertiary mirror.

11. The optical system of claim 1, wherein an aperture size associated with the optical system is greater than 50 centimeters.

12. An optical system comprising:
a first aspheric reflective surface for receiving input light;
a second aspheric reflective surface; and
a third spherical reflective surface,
wherein the second aspheric reflective surface is positioned to (i) direct light received from the first aspheric reflective surface onto the third spherical reflective surface, and (ii) direct light received from the third spherical reflective surface onto a detector,
wherein the first aspheric reflective surface and the third spherical reflective surface are arranged in a monolithic substrate in fixed alignment with respect to each other, and
wherein the second aspheric reflective surface is displaced at a distance away from the monolithic substrate and has a variable alignment with the first aspheric reflective surface and the third spherical reflective surface of the monolithic substrate.

13. The optical system of claim 12, wherein the second aspheric reflective surface is a Schmidt plate configured to limit spherical and off-axes aberrations in the light directed onto the detector, and wherein the second aspheric reflective surface is defined by a fourth-order polynomial.

14. The optical system of claim 12, further comprising one or more struts or an optical tube assembly that positions the second aspheric reflective surface at the distance away from the monolithic substrate.

15. The optical system of claim 12, wherein an aperture size of the optical system that corresponds to an outer diameter of the first aspheric reflective surface is greater than fifty centimeters.

16. The optical system of claim 12, wherein the detector is located within the monolithic substrate in fixed alignment with the first aspheric reflective surface and the third spherical reflective surface.

17. A method of manufacturing an optical system, the method comprising positioning a secondary mirror at a distance away from a monolithic substrate that fixes a primary mirror and a tertiary mirror in alignment, the secondary mirror positioned to direct light received from the primary mirror onto the tertiary mirror.

18. The method of claim 17, further comprising:
attaching a first end of a strut to the monolithic substrate, wherein the secondary mirror is positioned at an opposite end of the strut at the distance away from the monolithic substrate.

19. The method of claim 18, wherein the first end of the strut comprises a ridged or grooved surface that corresponds to a grooved or ridged surface on the monolithic substrate.

20. The method of claim 17, wherein an aperture size associated with the optical system and defined by an outer diameter of the primary mirror of the monolithic substrate is greater than fifty centimeters.
